(19) United States
(12) Patent Application Publication
(10) Pub. No.: US 2025/0065405 A1
(43) Pub. Date: Feb. 27, 2025

(54) METHOD FOR PRODUCING A MOLDING ELEMENT WITH REMOVAL OF MATERIAL FROM A POROUS REGION AND MOLD OBTAINED THEREBY

(71) Applicant: COMPAGNIE GENERALE DES ETABLISSEMENTS MICHELIN, Clermont-Ferrand (FR)

(72) Inventors: ROMAIN CALVEL, Clermont-Ferrand (FR); PATRICK ANDANSON, Clermont-Ferrand (FR); PIERRE CHIGROS, Clermont-Ferrand (FR); LIONEL LABEAU, Clermont-Ferrand (FR)

(21) Appl. No.: 18/720,924

(22) PCT Filed: Dec. 15, 2022
(86) PCT No.: PCT/EP2022/086236

§ 371 Date: Jun. 17, 2024

(30) Foreign Application Priority Data
Dec. 17, 2021 (FR) FR2113865

(51) Int. Cl. B22F 10/28; B22F 5/00; B29D 30/06; B33Y 10/00; B33Y 80/00

(52) U.S. Cl. CPC B22F 10/28; B22F 5/007; B29D 2030/0617; B33Y 10/00; B33Y 80/00

(57) ABSTRACT

A process for manufacturing a molding element (10) of a curing mold, the molding element being manufactured by an additive manufacturing process, the molding element comprising a molding inner surface (12) and an outer surface (14), and the molding element comprising at least one vent (20) through which air can pass between the molding inner surface and the outer surface of the molding element, comprises the following steps: (a) additively manufacturing the molding element and at least one porous region in this molding element, the porous region being manufactured so as to have a material density lower than the material density of the molding element outside this porous region, and (b) using a process for removal of material by a laser beam or by a laser beam contained in a water jet to produce at least one vent (20) in the porous region.

### TECHNICAL FIELD

The present invention relates to the manufacture of vents in a curing mould, and more particularly in a moulding element of a tyre curing mould.

Tyre denotes a casing, notably composed of various rubber compounds and reinforcing elements, which is mounted on a rim and filled with air or a particular gas in order to form a wheel with this rim. Tyre also denotes a casing, notably composed of various rubber compounds and reinforcing elements, which is mounted on a rim without being filled with air or a particular gas in order to form a wheel with this rim.

The presence of vents in a curing mould is necessary to evacuate the air which can be trapped between the object to be moulded and the curing mould when the mould is being closed and which can prevent the material of the object to be moulded conforming to the moulding surfaces of the curing mould. Notably, the vents are necessary in partitioned regions of the mould from which the air cannot be naturally evacuated, as can be the case at the interface between two moulding elements of the mould that are movable relative to one another.

### PRIOR ART

Patent FR 2 996 800 proposes manufacturing a moulding element of a tyre curing mould using a process of additive manufacture by powder layer deposition and selective melting. In addition, this patent FR 2 996 800 provides that the vents of the moulding element take the form of porous regions having a plurality of pores through which air can pass between the moulding inner surface of the moulding element and its outer surface. In more detail, the porous regions are obtained by modifying certain parameters of the additive manufacturing process, and notably by modifying certain parameters of the selective melting of the layers of powder.

According to a first drawback, it has been found that the porous regions described in patent FR 2 996 800 do not provide sufficient ventilation, which is to say that they do not provide a sufficient flow rate of air.

According to another drawback, after a curing mould comprising moulding elements with porous regions has been used several times to manufacture a tyre, the pores of the porous regions may become blocked little by little by the rubber material used to manufacture the tyre and the pores thus blocked may prove very hard to clean given their very small cross sections.

Document DE102014216865 proposes producing vents in a moulding element of a tyre curing mould by removal of material using a laser beam contained in a water jet. More specifically, this document DE102014216865 proposes using this material removal process to produce venting slots having a width of between 30 and 100 μm, a length of between 10 and 40 mm, and a depth of between 2 and 5 mm.

One drawback of the solution set out in this document DE102014216865 is the relatively long time needed to produce the numerous vents that may be provided in a moulding element.

### SUMMARY OF THE INVENTION

The aim of the present invention is to address the drawbacks of the prior art.

To this end, the invention relates to a process for manufacturing a moulding element of a curing mould, said moulding element being manufactured by a process of additive manufacture by powder layer deposition and selective melting of the layers of powder, the moulding element comprising a moulding inner surface and an outer surface on the opposite side from the moulding inner surface, and the moulding element comprising at least one vent through which air can pass between the moulding inner surface and the outer surface of the moulding element.

According to the invention, the manufacturing process comprises the following steps:
a) additively manufacturing the moulding element and at least one porous region in this moulding element, the porous region being manufactured so as to have a material density lower than the material density of the moulding element outside this porous region, and
b) using a material removal process to produce at least one vent in the porous region.

Still according to the invention, the vent is produced in the porous region during step b) using a laser beam or a laser beam contained in a water jet.

Since it is easier to remove material in a porous region of lower material density, step b) of producing a vent can be carried out more quickly, thereby decreasing the time taken to produce vents and costs involved in producing vents in a moulding element of a curing mould, and therefore the cost of manufacturing a curing mould.

Advantageously, but not necessarily, the invention may also provide that:
the contour defined by the porous region in the moulding inner surface after step a) has been carried out contains the contour defined by the vent in the moulding inner surface after step b) has been carried out or corresponds to the contour defined by the vent in the moulding inner surface after step b) has been carried out,
with the vent produced during step b) taking the form of a slot, the porous region has a width at least equal to the width of the slot,
the porous region manufactured during step a) has a width of between 0.02 mm and 3 mm, for example between 0.02 and 2 mm, and preferably of between 0.5 mm and 1 mm, and the slot produced during step b) in this porous region has a width of between 0.03 mm and 0.07 mm,
the porous region has a width at least 0.4 mm, preferably at least 0.9 mm greater than the width of the slot,
the porous region manufactured during step a) has a depth of between 0.1 mm and 3 mm, and preferably of between 0.5 mm and 2 mm, wherein the slot produced during step b) in this porous region has a depth of between 0.1 mm and 3 mm, and preferably of between 0.5 mm and 2 mm,
the moulding element has a material density greater than 98% outside the porous region, wherein the porous region has a material density less than 98%,
the porosity of the porous region manufactured during step a) is obtained by modifying the parameters of the selective melting in the regions of the layers of powder corresponding to sections of the porous region,
with the selective melting being effected using a selective-melting laser beam, the parameters of the selective melting that are modified for the manufacture of the porous region include the following: the distance between the paths taken by the spot of the selective-melting laser beam over the layers of powder, the power of the selective-melting laser beam, the velocity of the spot of the selective-melting laser beam over the layers of powder, and/or the diameter of the spot of the selective-melting laser beam on the layers of powder,
the one or more last layers of powder making up the upper part of a porous region and forming part of the moulding inner surface are fused with the same material density as the moulding element outside this porous region, for example with a material density greater than 98%,
the vent leads into a clearance made in the outer surface of the moulding element, the clearance allowing more air to pass through than the vent does,
the curing mould is a tyre curing mould.

The invention also relates to a moulding element of a curing mould comprising at least one vent through which air can pass between the moulding inner surface and the outer surface of the moulding element, and at least one porous region next to this vent.

The invention also relates to a curing mould, notably a tyre curing mould, comprising at least one moulding element comprising at least one vent and at least one porous region next to this vent.

### DETAILED DESCRIPTION

Further features and advantages of the invention will become apparent from the following description. This description, given by way of non-limiting example, refers to the appended drawings, in which:

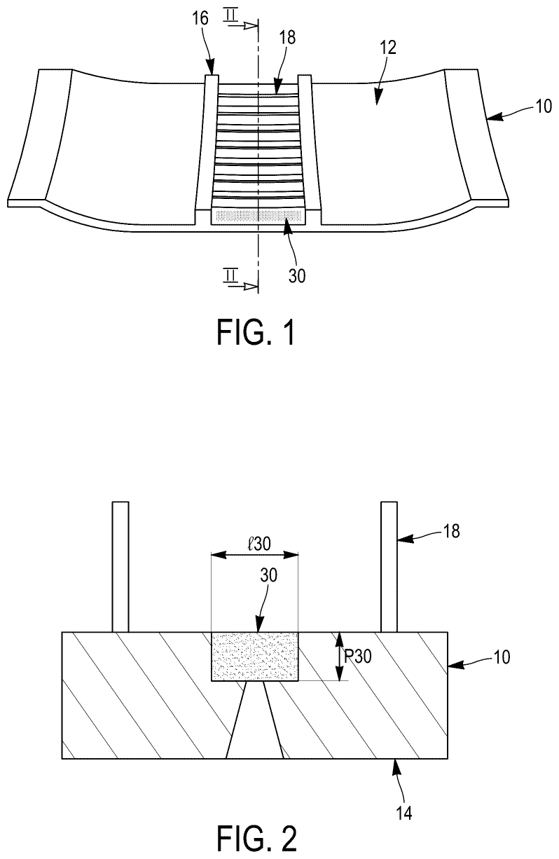

FIG. 1 schematically shows a perspective view of a moulding element of a curing mould with a porous region manufactured at the same time as this moulding element,

FIG. 2 schematically shows a sectional view in a transverse median plane of a moulding element of a curing mould with a porous region manufactured at the same time as this moulding element,

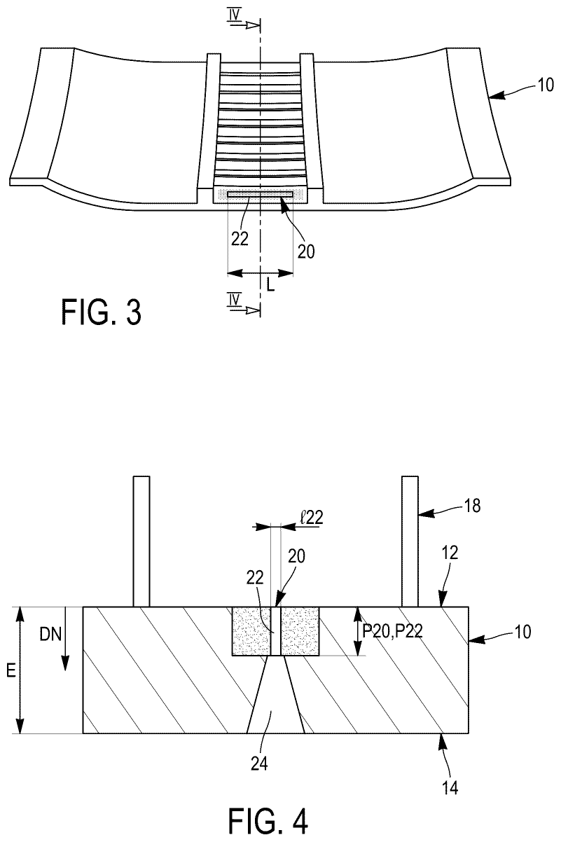

FIG. 3 schematically shows a perspective view of a moulding element of a curing mould with a vent produced in a porous region of this moulding element in accordance with the invention,

FIG. 4 schematically shows a sectional view in a transverse median plane of a moulding element of a curing mould with a vent produced in a porous region of this moulding element in accordance with the invention.

The invention relates to the manufacture of a moulding element of a curing mould such as a tyre curing mould.

In order to manufacture a tyre, in a first step a green tyre is assembled from semi-finished products taking the form of strips of rubber compounds, which are reinforced or not reinforced, and non-rubber components, such as metal bead wires. Then, this green tyre is placed in a curing mould in order to undergo a cycle of curing and moulding under pressure, which will give the tyre its final shape. Notably, it is during this step of curing and moulding under pressure that the patterns present on the tread of the tyre are created. The aim of the curing is also to ensure cohesion between the various components of the tyre, notably via vulcanization of the rubber compounds.

FIGS. 1 to 4 show a moulding element 10 which could be used in a tyre curing mould to shape the tread of this tyre. If this curing mould is a segmented mould, a moulding element 10 is mounted on a support belonging to a segment of this curing mould. In a segmented mould, the segments are movable relative to one another. In addition, each segment is movable between an open position used to introduce the green tyre or the object to be moulded into the curing mould and to extract the tyre after curing or the object that has just been moulded, and a closed position used for the curing and moulding under pressure of the green tyre or for the moulding of the object to be moulded.

As illustrated in FIGS. 1 and 2, the moulding element 10 comprises a moulding inner surface 12 and an outer surface 14 on the opposite side from the moulding inner surface. The outer surface 14 of the moulding element 10 is, for example, intended to be in contact with another part of the curing mould, such as with a support belonging to a segment of the curing mould.

For example, the moulding inner surface 12 comprises longitudinal walls 16 intended to create longitudinal grooves in the tread of the tyre or in the object to be moulded, and transverse sipe blades 18 crossing the longitudinal walls 16 and intended to create transverse sipes in the tread of the tyre or in the object to be moulded.

In order to make it possible to evacuate air that might be trapped between the moulding inner surface 12 and the green tyre or the object to be moulded, and particularly in a partitioned region like that located between two longitudinal walls 16 and two transverse sipe blades 18, the moulding element 10 comprises at least one vent 20 through which air can pass between the moulding inner surface 12 and the outer surface 14 of the moulding element.

As shown in FIGS. 3 and 4, a vent 20 is an orifice passing all the way through a moulding element 10. A vent preferably extends in a direction DN normal to the moulding inner surface 12. A vent may take various forms. In a preferred embodiment, a vent 20 takes the form of a slot 22. The opening created by the slot 22 in the moulding inner surface 12 preferably has a shape, notably rectangular or oblong shape, which is longer than it is wide. The opening created by the slot 22 in the moulding inner surface 12 may extend along a rectilinear line in the moulding inner surface 12, or along a curved line in the moulding inner surface 12, for example so as to follow the curvature of a curved transverse sipe blade 18.

In a preferred embodiment of a moulding element 10, a vent 20 has a depth P20 of between 0.5 and 3 millimetres, and preferably of between 1 and 2 millimetres. The depth P20 of a vent 20 is measured in the normal direction DN in which this vent 20 extends from the moulding inner surface 12. The depth P20 of a vent is limited to reduce the time spent on manufacturing this vent and to make it easier to clean this vent after one or more use cycles of the mould.

In order to limit the depth P20 of a vent, the vent 20 preferably leads into a clearance 24 made in the outer surface 14 of the moulding element. A clearance 24 allows more air to pass through than the vent 20 does. A clearance 24 does not lead into the moulding inner surface 12. A clearance 24 extends only over some of the thickness E of a moulding element 10, the thickness E being the distance separating the moulding inner surface 12 from the outer surface 14. The depth P20 of a vent must be sufficient to avoid the moulded material flowing out of the vent and accumulating in the clearance 24.

A vent 20, and notably a slot 22, has a length L from a few millimetres to several centimetres.

According to the invention, the process for manufacturing a moulding element 10 comprises the following steps:
a) additively manufacturing the moulding element 10 and at least one porous region 30 in this moulding element, the porous region being manufactured so as to have a material density lower than the material density of the moulding element outside this porous region, and
b) using a material removal process to produce at least one vent 20 in the porous region.

During step a), the moulding element 10 and the porous region 30 are manufactured by a process of additive manufacture by powder layer deposition and selective melting of the layers of powder.

Additive manufacturing by powder bed deposition and selective melting is an additive manufacturing process in which one or more objects are manufactured by the selective melting of various mutually superposed layers of additive manufacturing powder. The first layer of powder is deposited on a support such as a plate, then selectively fused using one or more sources of energy or heat along a first horizontal section of the one or more objects to be manufactured. Then, a second layer of powder is deposited on the first layer of powder that has just been fused, and this second layer of powder is selectively fused in turn, and so on, until the last layer of powder that is useful for manufacturing the last horizontal section of the one or more objects to be manufactured is reached.

In the present invention, a layer of powder is selectively melted, for example, by the movement, referred to as sweeping, of the spot of at least one laser beam over said layer of powder.

For example, the moulding element 10 and the porous region 30 are additively manufactured on an additive manufacturing plate belonging to a machine for additive manufacture by powder bed deposition and selective laser melting. At the end of the additive manufacturing, the moulding element 10 is secured to the additive manufacturing plate, notably via supports which are also additively manufactured on this plate. These supports are intended to make it easier to separate the moulding element from the additive manufacturing plate and also make it possible to support parts of the moulding element that would otherwise be suspended without support above the plate or other parts of the moulding element.

The moulding element 10 and the porous region 30 are preferably manufactured from a metal alloy. For example, the moulding element 10 and the porous region 30 are manufactured from a steel of the maraging type.

In order to implement step b), the moulding element 10 is for example detached from the additive manufacturing plate, and possibly also from these supports.

During step a), the manufacturing process according to the invention provides manufacturing a porous region 30 which has a material density less than the material density of the moulding element outside this porous region.

For example, the moulding element has a material density greater than 98% outside the porous region, and the porous region has a material density less than 98%.

In the context of additive manufacturing, the material density of a manufactured object is directly linked to the quality of the melt pool and to the porosity created in the object by the use of selective melting. For example, an object having a material density equal to 100% has no porosity, and an object having a material density equal to 90% contains 10% by volume of pores, which is to say gaps filled with gas and not with solid material. The material density of a manufactured object is measured by destructive cutting of the object and then polishing and image analysis (measurement of the ratio of holes to solid matter), by tomography, using the Archimedes principle or a pycnometer. The aim is generally to avoid porosity since it adversely affects the mechanical characteristics of the manufactured object. In the present invention, the porosity of the porous region is an advantage since it makes it easier to carry out step b) of the manufacturing process, which is to say the removal of material in this porous region, by adversely affecting the mechanical characteristics of the constituent material of this porous region and notably by reducing its resistance to a material removal process.

According to the invention, the porosity of the porous region manufactured during step a) is obtained, for example, by modifying the parameters of the selective melting in the regions of the layers of powder corresponding to sections of the porous region. If the selective melting is effected using a selective-melting laser beam, the parameters of the selective melting that are modified for the manufacture of the porous region 30 include, for example, the following: the distance between the paths taken by the spot of the selective-melting laser beam over the layers of powder, the power of the selective-melting laser beam, the velocity of the spot of the selective-melting laser beam over the layers of powder, and/or the diameter of the spot of the selective-melting laser beam on the layers of powder.

For example, when the paths taken by the spot of the selective-melting laser beam are mainly composed of mutually parallel vectors evenly spaced apart by a distance referred to as space between vectors, this distance between vectors is greater for the production of the porous region than the distance between vectors used to produce the moulding element outside the porous region.

As an alternative or in addition to modifying the distance between the paths taken by the spot of the selective-melting laser beam, the power of the selective-melting laser beam is weaker for the production of the porous region than for the production of the moulding element outside the porous region.

As an alternative or in addition to modifying the distance between the paths taken by the spot of the selective-melting laser beam and to modifying the power of the selective-melting laser beam, the diameter of the spot of the selective-melting laser beam on the layers of powder is greater during the production of the porous region than during the production of the moulding element outside the porous region.

As an alternative or in addition to the aforementioned modifications, the velocity of the spot of the selective-melting laser beam over the layers of powder is greater for the production of the porous region than for the production of the moulding element outside the porous region.

For example, a laser beam used to additively manufacture the moulding element and at least one porous region in this moulding element is an ytterbium fibre laser having a wavelength of between 400 and 1100 nm, and preferably of between 1030 and 1100 nm.

Advantageously, in the process according to the invention, the contour defined by the porous region 30 in the moulding inner surface 12 can be adapted to all forms, notably that of a slot, that can be taken by the vent: wavy, curved, zigzag-shaped, etc.

### Step b) by Way of a Chemical Bath

In a first embodiment of step b), the vent 20 is produced in the porous region 30 during step b) using a chemical attack effected in a chemical bath. To implement this chemical attack, the moulding element 10 is removed from the additive manufacturing machine in which it was manufactured, and preferably the moulding element 10 is separated from the manufacturing plate on which it was manufactured in the additive manufacturing machine.

In this first embodiment of step b), the process for removal of material by chemical attack is a surface treatment process. This process makes it possible to remove the metal from the surfaces of the moulding element ion by ion.

When the chemical attack is being carried out, the moulding element 10 is preferably completely immersed in the chemical bath.

Advantageously, the porous region 30 is a region which is eroded more by the chemical attack than the other regions of the moulding element. In other words, the porous material forming the porous region 30 undergoes the chemical attack to a greater extent than the constituent non-porous material of the moulding element outside the porous region.

Ideally, the moulding element 10 is cleaned and rinsed before carrying out step b). The moulding element 10 may possibly also be stripped before carrying out step b). After step b) has been carried out, the moulding element is at least rinsed, and an after-treatment can also be performed to remove the residues of the chemical attack.

In a preferred alternative way of carrying out the chemical attack on a porous region, the removal of material by chemical attack is effected by immersing the moulding element in a solely chemical bath. This solely chemical bath comprises, for example, at least one acid, and possibly at least one additive such as a surfactant, a viscosity regulator or a brightening agent. Possibly, for an optimum chemical attack, the chemical bath can be heated and temperature-controlled.

To improve the effect of the surface treatment, the chemical attack may also be combined with an electrolytic action.

In a second alternative way of carrying out the chemical attack on a porous region, the removal of material by chemical attack in step b) is effected by immersing the moulding element in a chemical and electrolytic bath. This process for surface treatment by chemical and electrolytic action is also referred to as electro-polishing. To bring about the electrolytic action, a preferably DC electric current flows through the moulding element. In more detail, the moulding element is connected to an anode, whereas one or more cathodes are also immersed in the chemical and electrolytic bath. For example, the chemical and electrolytic bath is a mixture of phosphoric acid and sulfuric acid.

In a third alternative way of carrying out the chemical attack on a porous region, the removal of material by chemical attack in step b) is effected by immersing the moulding element in a chemical and electrolytic bath and generating a plasma around the moulding element. To generate the plasma, an electric current and voltage greater than those required for a simple electrolytic action flow through the moulding element.

In this first embodiment of step b), all of the material of the porous region 30 is for example removed by the chemical attack effected in the chemical and possibly electrolytic bath. In this case, the contour defined by the porous region 30 in the moulding inner surface after step a) has been carried out corresponds to the contour defined by the vent 20 in the moulding inner surface after step b) has been carried out.

Possibly, by reducing the duration or the effect of the chemical attack in the chemical bath, the contour defined by the porous region 30 in the moulding inner surface after step a) has been carried out contains the contour defined by the vent 20 in the moulding inner surface after step b) has been carried out. In this case, porous material remains around the vent after step b) has been carried out.

For example, in this first embodiment of step b), if the vent produced during step b) takes the form of a slot 22, the porous region 30 has a width 130 at least equal to the width I22 of the slot. The width I22 of a slot 22 is the smallest dimension of the opening created by this slot 22 in the moulding inner surface 12.

In more detail, and still in this first embodiment of step b), the porous region 30 manufactured during step a) has a width 130 of between 0.01 mm and 0.07 mm, and preferably of between 0.03 mm and 0.05 mm, and the slot 22 produced during step b) in this porous region has a width I22 of between 0.02 mm and 0.06 mm. In addition, the porous region 30 manufactured during step a) has a depth P30 of between 0.1 mm and 3 mm, and preferably of between 0.5 mm and 2 mm, and the slot 22 produced during step b) in this porous region also has a depth P22 of between 0.1 mm and 3 mm, and preferably of between 0.5 mm and 2 mm.

Advantageously, by limiting the depth P22 of a slot, the duration of step b) is reduced and therefore the cost of manufacturing the moulding element 10 is reduced.

### Step b) by Laser Beam

In a second embodiment of step b), the vent 20 is produced in the porous region 30 during step b) using a laser beam. In a preferred variant of this second embodiment, the laser beam used to realize the removal of material in the porous region 30 may be contained in a water jet, it being possible for the water jet itself to be contained in a stream of gas. The water jet makes it possible to guide the laser beam like an optical fibre and to obtain a vent 20 with walls parallel to the direction DN normal to the moulding inner surface 12. To implement the removal of material in the porous region 30 by laser beam, the moulding element 10 is preferably removed from the additive manufacturing machine in which it was manufactured and placed in a laser machining machine. As a result, the laser beam used to remove material is separate from the laser beam used to additively manufacture the moulding element 10. To carry out step b), the moulding element 10 is for example separated from the manufacturing plate on which it was manufactured in the additive manufacturing machine.

The types of laser used for the removal of material by laser beam are green lasers of wavelength equal to 532 nm for example, or infrared-type lasers.

In this second embodiment of step b) for example, only some or all of the material of the porous region 30 is removed by the laser beam. In this case, the contour defined by the porous region in the moulding inner surface after step a) has been carried out contains the contour defined by the vent in the moulding inner surface after step b) has been carried out or corresponds to the contour defined by the vent in the moulding inner surface after step b) has been carried out.

In this second embodiment of step b), the aim is to avoid removing non-porous material of the moulding element using the laser beam so as to avoid excessively lengthy machining times. In addition, a porous region wider than the vent provides a greater tolerance for repositioning the moulding element between steps a) and b).

For example, in this second embodiment of step b), if the vent produced during step b) takes the form of a slot 22, the porous region 30 has a width 130 at least equal to the width I22 of the slot.

In more detail, and still in this second embodiment of step b), the porous region 30 manufactured during step a) has a width 130 of between 0.02 mm and 3 mm, for example between 0.02 and 2 mm, and preferably of between 0.05 mm and 1 mm, and the slot 22 produced during step b) in this porous region has a width I22 of between 0.03 mm and 0.07 mm. Ideally, to ensure that the laser beam removes material solely from the porous region, this porous region has a width 130 at least 0.4 mm, preferably at least 0.9 mm greater than the width I22 of the slot. This is because different additively manufactured moulding elements can have slight dimensional variations liable to modify the positioning of the laser beam in relation to the moulding element in the machine where the material is removed. In addition, the porous region 30 manufactured during step a) has a depth P30 of between 0.1 mm and 3 mm, and preferably of between 0.5 mm and 2 mm, and the slot 22 produced during step b) in this porous region has a depth P22 of between 0.1 mm and 3 mm, and preferably of between 0.5 mm and 2 mm.

Advantageously, the process according to the invention provides limiting the width 130 of the porous region 30 to the greatest possible extent to avoid this porous region leaving excessively visible traces of porosity on the tyre when this porous region leads into the moulding inner surface 12 of the moulding element.

In order that the porous region does not leave any trace of porosity visible on the tyre, the process according to the invention may provide that the one or more last layers of powder making up the upper part of a porous region 30 and forming part of the moulding inner surface 12 are fused with the same material density as the moulding element outside this porous region, for example with a material density greater than 98%.

The invention also covers a moulding element of a curing mould comprising at least one vent through which air can pass between the moulding inner surface and the outer surface of the moulding element, and at least one porous region next to this vent. For example, the invention covers a moulding element 10 in which only some of the material of a porous region 30 has been removed to create a vent 20. Thus, the invention covers a moulding element 10 in which, after being manufactured and during use, at least one vent and at least one porous region coexist. This moulding element is, for example, manufactured by a process of additive manufacture by powder layer deposition and selective melting of the layers of powder, and the porosity of the porous region is for example obtained by modifying the parameters of the selective melting in the regions of the layers of powder corresponding to sections of the porous region.

The invention also covers a curing mould, notably a tyre curing mould, comprising at least one moulding element comprising at least one vent and at least one porous region next to this vent.

1.-12. (canceled)

13. A process for manufacturing a molding element of a curing mold, the molding element being manufactured by a process of additive manufacture by powder layer deposition and selective melting of layers of powder, the molding element comprising a molding inner surface and an outer surface on an opposite side from the molding inner surface, and the molding element comprising at least one vent through which air can pass between the molding inner surface and the outer surface of the molding element, the manufacturing process comprising the following steps:
(a) additively manufacturing the molding element and at least one porous region in the molding element, the porous region being manufactured so as to have a material density lower than a material density of the molding element outside the at least one porous region; and
(b) using a material removal process to produce at least one vent in the porous region,
wherein the at least one vent is produced in the porous region during step (b) using a laser beam or a laser beam contained in a water jet.

14. The process for manufacturing a molding element of a curing mold according to claim 13, wherein a contour defined by the at least one porous region in the molding inner surface after step (a) has been carried out contains a contour defined by the at least one vent in the molding inner surface after step (b) has been carried out or corresponds to the contour defined by the at least one vent in the molding inner surface after step (b) has been carried out.

15. The process for manufacturing a molding element of a curing mold according to claim 14, wherein, with the at least one vent produced during step (b) taking a form of a slot (22), the porous region has a width at least equal to a width of the slot.

16. The process for manufacturing a molding element of a curing mold according to claim 15, wherein the porous region manufactured during step (a) has a width of between 0.02 mm and 3 mm, and
wherein the slot produced during step (b) in the porous region has a width of between 0.03 mm and 0.07 mm.

17. The process for manufacturing a molding element of a curing mold according to claim 15, wherein the porous region has a width at least 0.4 mm greater than the width of the slot.

18. The process for manufacturing a molding element of a curing mold according to claim 16, wherein the porous region manufactured during step (a) has a depth of between 0.1 mm and 3 mm, and
wherein the at least one slot produced during step (b) in the porous region has a depth of between 0.1 mm and 3 mm.

19. The process for manufacturing a molding element of a curing mold according to claim 13, wherein the molding element has a material density greater than 98% outside the porous region, and
wherein the porous region has a material density less than 98%.

20. The process for manufacturing a molding element of a curing mold according to claim 19, wherein a porosity of the porous region manufactured during step (a) is obtained by modifying parameters of the selective melting in regions of the layers of powder corresponding to sections of the porous region.

21. The process for manufacturing a molding element of a curing mold according to claim 20, wherein, with the selective melting being effected using a selective-melting laser beam, the parameters of the selective melting that are modified for the manufacture of the porous region include the following: a distance between paths taken by the spot of the selective-melting laser beam over the layers of powder, a power of the selective-melting laser beam, a velocity of the spot of the selective-melting laser beam over the layers of powder, and a diameter of the spot of the selective-melting laser beam on the layers of powder.

22. The process for manufacturing a molding element of a curing mold according to claim 13, wherein one or more last layers of powder making up an upper part of the porous region and forming part of the molding inner surface are fused with a same material density as the molding element outside the porous region.

23. The process for manufacturing a molding element of a curing mold according to claim 13, wherein the at least one vent leads into a clearance made in the outer surface of the molding element, the clearance allowing more air to pass through than the at least one vent does.

24. The process for manufacturing a molding element of a curing mold according to claim 13, wherein the curing mold is a tire curing mold.
